(19) United States
(12) Patent Application Publication
(10) Pub. No.: US 2006/0163017 A1
(43) Pub. Date: Jul. 27, 2006

(54) Hollow rod monotube shock absorber

(75) Inventor: Frank Verriet, Mississauga (CA)

Correspondence Address: CARLSON, GASKEY & OLDS, P.C., 400 WEST MAPLE ROAD, SUITE 350, BIRMINGHAM, MI, 48009, US

(73) Assignee: ArvinMeritor Technology, LLC

(21) Appl. No.: 11/040,204

(22) Filed: Jan. 21, 2005

(51) Int. Cl. F16F 9/00

(52) U.S. Cl. 188/315

(57) ABSTRACT

A shock absorber is provided with a pair of opposed hydraulic fluid chambers, and a piston head that controls the flow of hydraulic fluid between the opposed hydraulic fluid chambers. One of the hydraulic fluid chambers is provided within a hollow rod that moves with the piston head within a cylinder. Thus, a traditional solid piston rod has been modified such that the hollow rod provides one of the hydraulic fluid chambers. In this way, the number of sealing interfaces required in the prior art has been dramatically reduced. Further, compressed gas chambers are also defined within the cylinder and within the hollow rod, and a similar reduction in the number of sealing interfaces is provided.

### BACKGROUND OF THE INVENTION

This invention relates to a shock absorber having three hydraulic chambers and a pair of spaced gas compression chambers, and wherein a piston rod is utilized to provide two of the chambers.

Shock absorbers are utilized to dampen shock between a ground-engaging portion of a vehicle and the frame of the vehicle. In some cases, particularly on recreational vehicles, a mechanical or pneumatic spring is placed over the shock absorber so that the shock absorber also functions to moveably suspend the vehicle weight in addition to dampening shock.

In one known type of shock absorber, a piston moves within a cylinder. The piston is connected to either the ground-engaging portion or the frame of the vehicle, and the cylinder is connected to the other. As the ground-engaging portion moves, the piston moves within the cylinder.

The piston includes valves that allow the flow of a hydraulic fluid across the piston. Typically, the piston is movable within a pair of spaced hydraulic fluid chambers in the cylinder such that hydraulic fluid moves within the cylinder and between the hydraulic fluid chambers. The flow of the hydraulic fluid is more restricted in one direction than the other, such that a vehicle designer can control the effect of vibration, bounce, etc. on the frame of the vehicle. As an example, restricted flow of the hydraulic fluid may be more pronounced as the shock absorber moves to an extended position, compared to a collapsed position.

In one type of shock absorber, gas chambers are defined by additional floating piston heads, on an opposed side of each hydraulic fluid chamber. Thus, as the hydraulic fluid moves into and between the two hydraulic fluid chambers, the effect of continued movement of the piston is somewhat cushioned by compression of the gas in the gas chambers. The compression of the gas provides spring force that can moveably support a vehicle's weight. In order to provide enough force, the rod must be made considerably larger in diameter than normal, which in turn requires that the shock absorber be much longer for a given stroke.

In the known shock absorbers, the piston has a head connected to a solid piston rod. There has been a need to seal against the piston rod, and to provide sealing in both the hydraulic fluid chamber and the gas chamber.

It would be desirable to simplify this construction. The prior art requires a relatively long cylinder and is relatively heavy, or requires a second sealing surface that seals gas only. While power gas springs (i.e., springs with no hydraulic fluid) have been proposed that use a hollow piston rod as a gas chamber, such a configuration has not been applied to hydraulic fluid shock absorbers.

### SUMMARY OF THE INVENTION

In a disclosed embodiment of this invention, a shock absorber is provided with a piston head fixed to move with a hollow rod. The piston head includes valves. The piston head and the hollow rod are selectively movable within an outer cylinder. One hydraulic fluid chamber is defined between the piston head and an end of the outer cylinder, and an opposed hydraulic fluid chamber is defined within the hollow rod, between the piston head and an end of the hollow rod. A third chamber is defined between the inner peripheral surface of the outer cylinder and the outer peripheral surface of the hollow rod. Thus, one of the opposed hydraulic fluid chambers is defined within the hollow rod, rather than within a third outer cylinder. Similarly, a floating piston is received within the hollow rod, and separates a gas chamber from a hydraulic fluid chamber, reducing the shock absorber length required to accommodate a given stroke length.

Since the floating piston is received within the hollow rod, and the hydraulic fluid chamber is also within the hollow rod, seals between the outer cylinder and a third outer cylinder are not necessary. Instead, such seals are eliminated.

The hollow rod is connected to one of a ground-engaging portion of a vehicle and a frame of the vehicle, and the outer cylinder is connected to the other. The inventive shock absorber operates to dampen vibration and to movably support the vehicle's weight. In particular, as the hollow rod moves relative to the outer cylinder, the hydraulic fluid chambers and the gas chambers operate to control and produce a desired response to any such vibrational inputs.

Again, by eliminating several seals, the present invention simplifies the overall operation and construction of such shock absorbers.

The present invention can be shorter, generally lighter weight, and has fewer components. Moreover, a seal provided between an outer periphery of the hollow rod and an inner periphery of the outer cylinder would tend to seal on a hydraulic fluid. Such a “wet” seal typically has a longer life than a “dry seal” as would have been found in the prior art against sealing a gas chamber.

These and other features of the present invention can be best understood from the following specification and drawings, the following of which is a brief description.

### BRIEF DESCRIPTION OF THE DRAWINGS

FIG. 1 shows the inventive shock absorber in an extended position.

FIG. 2 shows the FIG. 1 shock absorber in a collapsed position.

FIG. 3 is a detailed view of a piston incorporated into the present invention.

FIG. 4 is a cross-sectional view through the inventive shock absorber.

### DETAILED DESCRIPTION OF THE PREFERRED EMBODIMENT

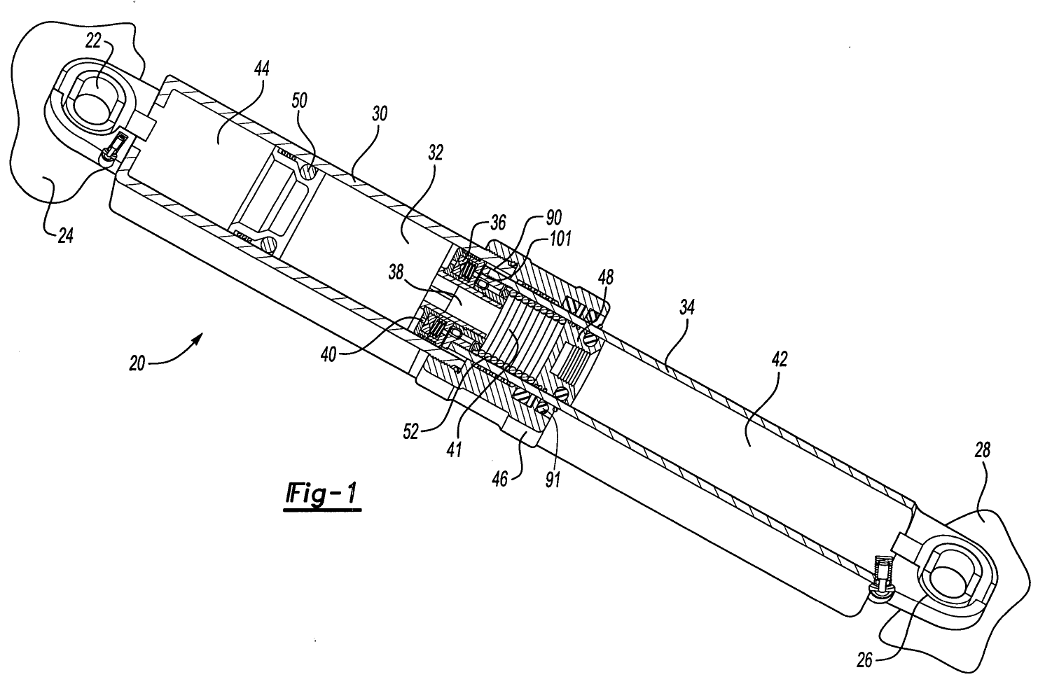

An inventive shock absorber 20 is illustrated in FIG. 1 having a first connecting portion 22 for being connected to a vehicle frame 24. An opposed connecting portion 26 is connected to a portion 28 of a vehicle that moves with a ground-engaging portion. As an example, the portion 28 would move with tracks on a snowmobile, a wheel of a wheeled vehicle, etc. Further, it should be understood that the opposed connecting portion 26 could be connected to the vehicle frame 24 with the first connecting portion 22 being connected to the ground-engaging portion.

The shock absorber 20 includes a cylinder 30 defining a hydraulic fluid chamber 32. A hollow rod 34 is fixed to a piston 36 that is movable within the cylinder 30. A passage 38 and valves 40 control the flow of hydraulic fluid from the hydraulic fluid chamber 32 into hydraulic fluid chambers 41 and 90, both on an opposed side of the piston 36. A spring 52 can bias the floating piston 48 away from piston 36 if the intended application requires a smoother transition between the two inherent gas spring rates arising from the two floating pistons.

The floating piston 48 defines a gas chamber 42, and a second floating piston 50 defines a gas chamber 44. As is known, the hydraulic fluid in the hydraulic fluid chambers 32, 41 and 90 is relatively incompressible. Gas in gas chambers 42 and 44 is compressible. As the hollow rod 34 and piston 36 move relative to the cylinder 30, hydraulic fluid moves between the hydraulic fluid chambers 32, 41 and 90. As this occurs, forces are placed on the floating pistons 48 and 50 that tend to compress or expand the gases in the gas chambers 42 and 44. The use and design of the opposed gas and hydraulic fluids in these chambers to achieve desired ride control may be as known in the art. The present invention is in providing the hydraulic fluid chamber 41 and the gas chamber 42 within the hollow rod 34.

Since the hollow rod 34 is utilized to provide the hydraulic fluid chamber 41 and the gas chamber 42, the length of the shock absorber is shortened over what it would be were the rod solid, as in a standard monotube shock absorber.

The present invention thus allows the elimination of a number of components. Further, the present invention can also be shorter and generally lighter weight. Moreover, a seal provided between an outer periphery of the hollow rod 34 and an inner periphery of the cylinder 30 would tend to seal on a hydraulic fluid. Such a “wet” seal typically has a longer life than a “dry seal” as would have been found in the prior art sealing against a gas chamber.

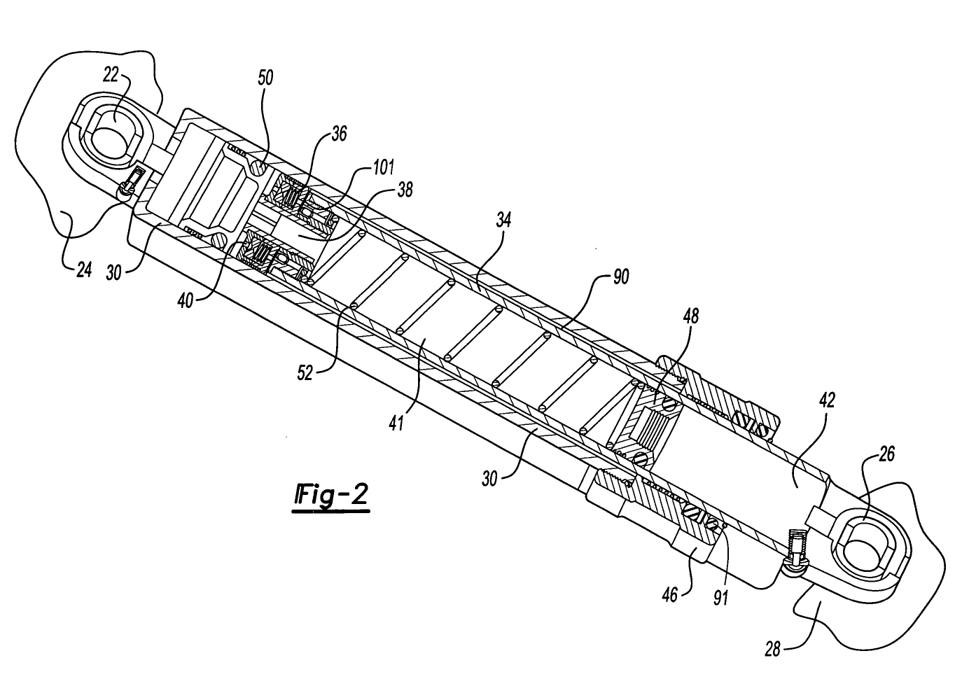

FIG. 1 shows the shock absorber 20 in an extended position. FIG. 2 shows the shock absorber 20 having moved to a compressed or collapsed position. In the compressed position, the hollow rod 34 and piston 36 have moved further into the cylinder 30. As can be seen, the floating piston 50 has been forced towards an end of the cylinder 30, and the floating piston 48 has moved far away from the piston 36 as the hydraulic fluid flows into the chambers 41 and 90. The gas in gas chamber 42 has thus been compressed from the position shown in FIG. 1, as has the gas in the gas chamber 44.

Sleeve 46 moves with the cylinder 30, and seals against an outer periphery of the hollow rod 34. Notably, seals 91 within sleeve 46 need only seal against hydraulic fluid. As discussed above, such a “wet” seal typically has a longer life than a “dry” seal.

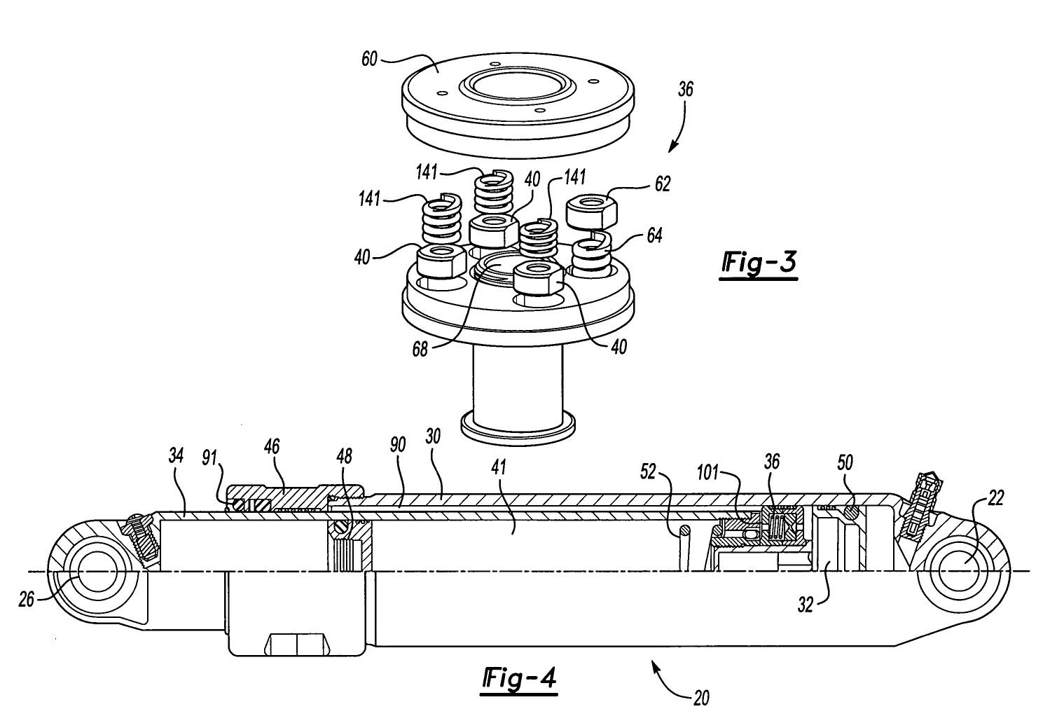

FIG. 3 shows a detail of the piston 36, including the valves 40 receiving springs 141, and a valve 62 receiving a spring 64. A piston head 60 captures all of the springs 141, 64 and valves 40, 62. Generally as known in the art, by controlling the strength of the springs 141 and 64, the resistance to flow of the hydraulic fluid between the two hydraulic fluid chambers 90 and 32 can be controlled. Again, this portion of the present invention is generally as known.

FIG. 4 is a cross-sectional view through the inventive shock absorber 20. A thin chamber 90 is defined between an outer periphery of the hollow rod 34 and an inner periphery of the cylinder 30. As shown in FIGS. 1 and 2, the volume of thin chamber 90 changes as the shock absorber 20 moves between its extended and collapsed positions. The thin chamber 90 communicates with hydraulic fluid through a passage 101, and thus, the thin chamber 90 provides additional cushioning. As can be appreciated, seals 91 within the sleeve 46 provide a fluid-tight seal at the outer periphery of the hollow rod 34. However, these seals 91 do not need to seal against a high pressure gas chamber.

The present invention thus provides a more simplified monotube shock absorber 20 than traditional designs. The inventive shock absorber 20 may be smaller, lighter weight and contain fewer components than the prior art.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A shock absorber comprising:
a cylinder; and
a hollow rod movable within said cylinder, said hollow rod carrying a main piston that defines a first hydraulic chamber between said main piston and an end of said cylinder, and a second hydraulic chamber being defined between said main piston and an outer end of said hollow rod, and said hollow rod wherein said main piston being are movable within said cylinder, with hydraulic fluid movable between said first hydraulic chamber and into and out of said second hydraulic chamber through said main piston.

2. The shock absorber as set forth in claim 1, wherein a first floating piston is disposed within said cylinder and defines said first hydraulic chamber on one side of said first floating piston, and wherein a first gas chamber is defined between said first floating piston and said end of said cylinder.

3. The shock absorber as set forth in claim 2, wherein a second floating piston is disposed within said hollow rod and defines said second hydraulic chamber between said main piston and said second floating piston, and wherein said second floating piston defines a second gas chamber between said second floating piston and said outer end of said hollow rod.

4. The shock absorber as set forth in claim 1, wherein a sleeve is attached to said cylinder, said sleeve sealing against an outer peripheral surface of said hollow rod.

5. The shock absorber as set forth in claim 4, wherein a third hydraulic chamber is defined between an inner peripheral surface of said cylinder and said outer peripheral surface of said hollow rod, with hydraulic fluid movable between said first hydraulic chamber and into and out of said third and second hydraulic chambers through said main piston.

6. The shock absorber as set forth in claim 1, wherein said main piston includes a free flow path between said first hydraulic chamber and said second hydraulic chamber.

7. The shock absorber as set forth in claim 6, wherein at least one valve is placed within said main piston, said at least one valve controlling the flow of hydraulic fluid between said first hydraulic chamber and said second hydraulic chamber to be more restrictive in one direction of movement than in an opposed direction of movement.

8. A vehicle and shock absorber comprising:
a pair of attachment points, with one of said pair of attachment points being attached to a cylinder and the other of said pair of attachment points being fixed to a hollow rod, and with one of said pair of attachment points being attached to the frame of a vehicle, and the other of said attachment points being attached to a portion of a vehicle that moves with a ground-engaging portion; and
wherein said hollow rod is movable within said cylinder and carries a main piston, said main piston defining a first hydraulic chamber between said main piston and an end of said cylinder, and a second hydraulic chamber being defined between said main piston and an outer end of said hollow rod, with said hollow rod and said main piston being movable within said cylinder, and with hydraulic fluid being movable between said first hydraulic chamber and into and out of said second hydraulic chamber through said main piston.

9. The vehicle and shock absorber as set forth in claim 8, wherein a first floating piston is disposed within said cylinder and defines said first hydraulic chamber on one side of said first floating piston, and wherein a first gas chamber is defined between said first floating piston and said end of said cylinder.

10. The vehicle and shock absorber as set forth in claim 9, wherein a second floating piston is disposed within said hollow rod and defines said second hydraulic chamber between said main piston and said second floating piston, and wherein said second floating piston defines a second gas chamber between said second floating piston and said outer end of said hollow rod.

11. The vehicle and shock absorber as set forth in claim 8, wherein a sleeve is attached to said cylinder, said sleeve sealing against an outer peripheral surface of said hollow rod.

12. The vehicle and shock absorber as set forth in claim 11, wherein a third hydraulic chamber is defined between an inner peripheral surface of said cylinder and said outer peripheral surface of said hollow rod, and with hydraulic fluid being movable between said first and said second hydraulic chambers into and out of said third hydraulic chamber through said main piston.

13. The vehicle and shock absorber as set forth in claim 8, wherein said main piston includes a free flow path between said first hydraulic chamber and said second hydraulic chamber.

14. The vehicle and shock absorber as set forth in claim 13, wherein at least one valve is placed within said main piston, said at least one valve controlling the flow of hydraulic fluid between said first hydraulic chamber and said second hydraulic chamber to be more restrictive in one direction of movement than in an opposed direction of movement.

15. A shock absorber comprising:
a cylinder;
a hollow rod movable within said cylinder carrying a main piston, said main piston defining a first hydraulic chamber between said main piston and an end of said cylinder, and a second hydraulic chamber being defined between said main piston and an outer end of said hollow rod, and said hollow rod and said main piston being movable within said cylinder, with hydraulic fluid movable between said first hydraulic chamber and into and out of said second hydraulic chamber through said main piston; and
a first floating piston disposed within said cylinder, said first floating piston defining said first hydraulic chamber between said main piston and said first floating piston, and said first floating piston defining a first gas chamber between said first floating piston and said end of said cylinder, a second floating piston disposed within said hollow rod, and said second floating piston defining said second hydraulic fluid chamber between said main piston and said second floating piston, and said second floating piston defining a second gas chamber between said second floating piston and said outer end of said outer rod, and a sleeve attached to said cylinder, said sleeve sealing against an outer peripheral surface of said hollow rod.

16. The shock absorber as set forth in claim 15, wherein said main piston includes a free flow path between said first hydraulic chamber and said second hydraulic chamber.

17. The shock absorber as set forth in claim 16, wherein at least one valve is placed within said main piston, said at least one valve controlling the flow of hydraulic fluid between said first hydraulic chamber and said second hydraulic chamber to be more restrictive in one direction of movement than in an opposed direction of movement.

18. The shock absorber as set forth in claim 15, wherein a third hydraulic chamber is defined between an inner peripheral surface of said cylinder and said outer peripheral surface of said hollow rod.
